(19) United States
(12) Patent Application Publication
(10) Pub. No.: US 2012/0070174 A1
(43) Pub. Date: Mar. 22, 2012

(54) IMAGE FORMING APPARATUS AND IMAGE FORMING METHOD

(75) Inventor: Hirotaka Matsumoto, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/226,039

(22) Filed: Sep. 6, 2011

Related U.S. Application Data
(60) Provisional application No. 61/384,091, filed on Sep. 17, 2010.

(51) Int. Cl. G03G 15/20

(52) U.S. Cl. 399/69

(57) ABSTRACT

A image forming apparatus includes an electrostatic latent image carrier that carries an electrostatic latent image, a developer supplying unit that supplies a developer to the electrostatic latent image and forms a developer image, a transfer roller that transfers the developer image to a recording medium, a heating roller with a heater therein, a temperature sensor that detects the temperature of the heating roller, a heating roller driving mechanism that drives the heating roller, and a controller that cools down the heating roller if the controller determines that the temperature sensor detects a temperature equal to or higher than a first temperature within a threshold time after completion of image forming.

### CROSS-REFERENCE TO RELATED APPLICATIONS

This application is based upon and claims the benefit of priority from the prior the U.S. Patent Application No. 61/384,091, filed on Sep. 17, 2010, and the entire contents of which are incorporated herein by reference.

### FIELD

Embodiments described herein relate generally to an image forming apparatus and an image forming method.

### BACKGROUND

A fixing device of an electronic image forming apparatus includes a heating roller with a heater therein and a pressurizing roller covered with an elastic member.

The temperature of a thin-walled heating roller is suppressed from rising during feeding of a sheet by the sheet. However, once the sheet is completely fed, heat from both ends of the heating roller, in which the temperature increases because the sheet is not in contact with the roller, is conducted toward the central portion of the heating roller. In this state, when a heater of the heating roller is driven, the temperature of the heating roller increases excessively. Therefore, developer transferred to a recording medium is melted and attached to the heating roller. In addition, the melted developer is again attached to a subsequently transported recording medium.

This phenomenon is called a “overshoot phenomenon”, which causes image quality deterioration.

A technique is proposed in which, when the temperature of the heating roller is equal to or higher than a predetermined temperature during forming an image, the temperature of the heating roller is lowered by preliminarily running the fixing device.

However, in this technique, since heat conduction in the heating roller after forming an image is not considered, there is still a possibility of the overshoot phenomenon occurring.

### BRIEF DESCRIPTION OF THE DRAWINGS

FIG. 1 is a drawing illustrating a configuration of an image forming apparatus.

FIG. 2 is a cross-sectional view illustrating an overall structure of a fixing device.

FIG. 3 is a drawing illustrating the positional relationship between a first sensor and a second sensor.

FIG. 4 is a block diagram illustrating a configuration of the image forming apparatus.

FIG. 5 is a flowchart illustrating operation of the image forming apparatus.

FIG. 6 is a diagram illustrating a temperature distribution in the longitudinal direction of a heating roller.

### DETAILED DESCRIPTION

An image forming apparatus includes: an electrostatic latent image carrier that carries an electrostatic latent image; a developer supplying unit that supplies a developer to the electrostatic latent image and forms a developer image; a transfer roller that transfers the developer image to a recording medium; a heating roller with a heater therein; a temperature sensor that detects the temperature of the heating roller; a heating roller driving mechanism that drives the heating roller; and a controller that cools down the heating roller if the controller determines that the temperature sensor detects a temperature equal to or higher than a first temperature within a threshold time after completion of image forming.

Hereinafter, an exemplary embodiment of an image forming apparatus and image forming method will be described with reference to the accompanying drawings. Here, the image forming apparatus includes a copy machine, a Multifunctional Peripheral (MFP), and a printer.

The image forming apparatus according to the exemplary embodiment includes: an electrostatic latent image carrier that carries an electrostatic latent image; a developer supplying unit that supplies a developer to the electrostatic latent image and forms a developer image; a transfer roller that transfers the developer image to a recording medium; a heating roller with a heater therein; a temperature sensor that detects the temperature of the heating roller; a heating roller driving mechanism that drives the heating roller; and a controller that cools down the heating roller if the controller determines that the temperature sensor detects a temperature equal to or higher than a first temperature within a threshold time after completion of image forming.

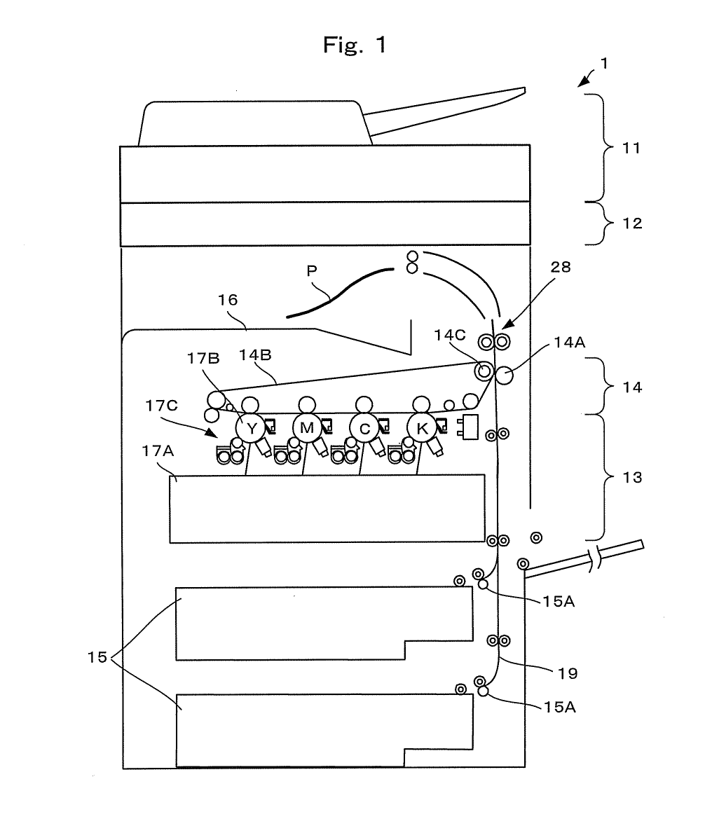

FIG. 1 is a drawing illustrating a configuration of an image forming apparatus 1. As illustrated in FIG. 1, the image forming apparatus 1 includes an automatic document feeder 11, an image scanner 12, an image forming unit 13, a transfer unit 14, a recording medium transporting mechanism 19, and a sheet feeding unit 15.

The image forming apparatus 1 includes the automatic document feeder 11 on an upper portion thereof so as to be openable. The automatic document feeder 11 includes a document transporting mechanism which picks up a document one sheet at a time from a feed tray and transports the sheets to a discharge tray.

The automatic document feeder 11 transports the document one sheet at a time to a document scanning portion of the image scanner 12 using the document transporting mechanism. It is also possible to open the automatic document feeder 11 and put a document on a platen of the image scanner 12.

The image scanner 12 includes a carriage with a first reflecting mirror and an exposure lamp exposing a light to the document, plural second reflecting mirrors which are locked at a body frame of the image forming apparatus 1, a lens block, and a Charge Coupled Device (CCD) of an image scanning sensor.

The carriage stops at the document scanning portion or reciprocates under the platen, and then reflects light from the exposure lamp, which is reflected from the document, to the first reflecting mirror. The plural second reflecting mirrors reflect the light reflected from the first reflecting mirror to the lens block. The lens block emits the reflecting light to the CCD. The CCD converts the reflecting light to an electric signal and outputs the electric signal to the image forming unit 13 as an image signal.

The image forming unit 13 includes, for each of yellow Y, magenta M, cyan C, and black K, a laser emitting unit 17A, a photoconductor drum 17B serving as a electrostatic latent image carrier, and a developer supplying unit 17C.

The laser emitting unit 17A emits laser light to the photoconductor drum 17B on the basis of the image signal and forms an electrostatic latent image on the photoconductor drum 17B. The developer supplying unit 17C supplies a developer to the photoconductor drum 17B and forms a developer image from the electrostatic latent image.

The recording medium transporting mechanism 19 includes a pick-up mechanism 15A which picks up a recording medium one sheet at a time at the furthest upstream of the sheet feeding unit 15 side.

The pick-up mechanism 15A picks up a recording medium one by one from the sheet feeding unit 15 and delivers the recording medium to the recording medium transporting mechanism 19. The recording medium transporting mechanism 19 transports the recording medium to the transfer unit 14.

The transfer unit 14 includes a transfer belt 14B, a transfer roller 14A, and a fixing device 28. The transfer belt 14B is suspended around a counter roller 14C facing the transfer roller 14A. The transfer belt 14B serving as the image carrier carries the developer image transferred from the photoconductor drum 17B. The transfer roller 14A applies a voltage to transfer the developer image of the transfer belt 14B on the transported recording medium. The fixing device 28 is provided downstream of the transfer unit 14 in a direction of transporting the recording medium, and applies heat and pressure to the developer image to fix the developer image on the recording medium.

According to another exemplary embodiment of the image forming apparatus 1, the developer image is transferred on the recording medium directly from the photoconductor drum 173. In this case, the transfer roller 14A is disposed so as to face the photoconductor drum.

The recording medium P discharged from a discharge port is stacked on a discharge tray 16 serving as a holder which holds the recording medium.

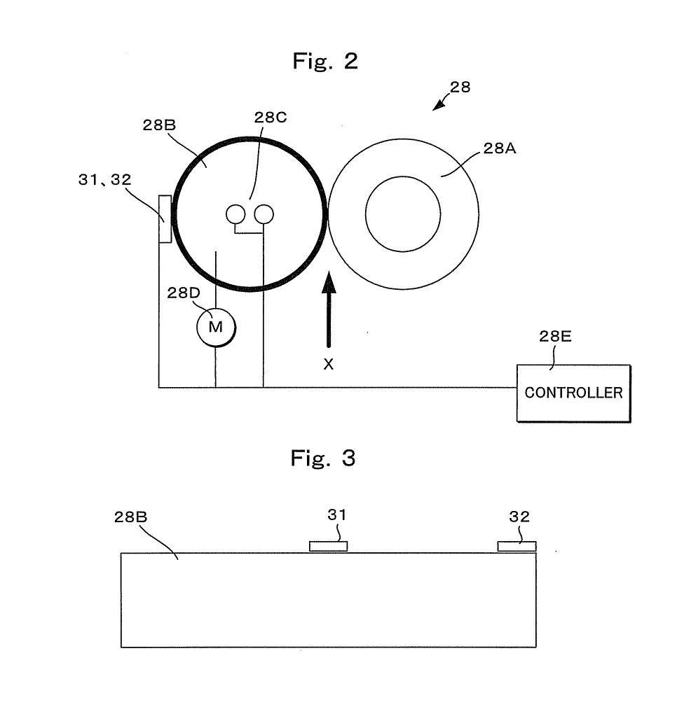

FIG. 2 is a cross-sectional view illustrating an overall structure of a fixing device 28. As illustrated in FIG. 2, the fixing device 28 includes: a heating roller 28B with a heater 28C therein; a pressurizing roller 28A which is disposed so as to face the heating roller 28B with a recording medium transporting path interposed therebetween; central and side sensors 31 and 32 which serve as first and second temperature sensors, respectively and detect the temperature of the heating roller 28B; a heating roller driving unit 28D which drives the heating roller 28B; and a controller 28E which receives an output from the central and side sensors 31 and 32 and controls the heater 28C and the heating roller driving unit 28D.

The recording medium is transported in a direction indicated by the arrow X. As the central and side sensors 31 and 32, a thermistor can be used. However, the sensors are not limited to a thermistor.

The controller 28E detects the temperature of the heating roller 28B from the output of the central and side sensors 31 and 32, and controls the heater 28C such that the temperature of the heating roller 28B is within a predetermined range.

The controller 28E detects the surface temperature of the pressurizing roller 28A from the output of the central and side sensors 31 and 32, and controls, on the basis of the surface temperature, rotational operation before forming an image, that is, preliminary run.

FIG. 3 is a drawing illustrating the positional relationship between a first sensor and a second sensor. As illustrated in FIG. 3, the central sensor 31 is disposed at a central portion in the longitudinal direction of the heating roller 28B, and the side sensor 32 is disposed at an end in the longitudinal direction of the heating roller 28B.

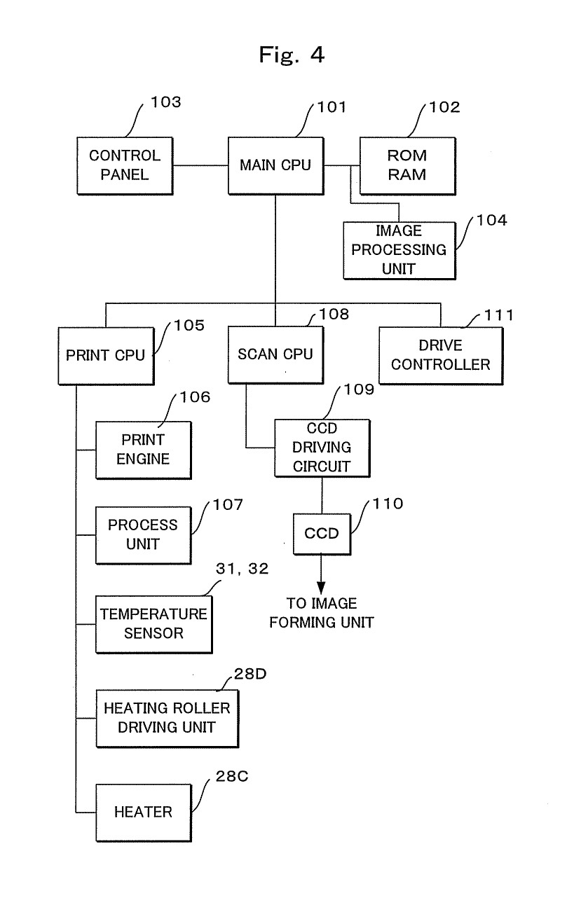

FIG. 4 is a block diagram illustrating a configuration of the image forming apparatus 1. As illustrated in FIG. 4, the image forming apparatus 1 includes a main CPU 101, a control panel 103 as a display input device, a ROM and RAM 102 as a storage device, and an image processing unit 104 which processes an image.

The main CPU 101 is connected to a print CPU 105 included in the image forming apparatus 1, a scan CPU 108, and a drive controller 111, and controls them.

The print CPU 105 as the controller 28E is connected to a print engine 106 for forming an image, a process unit 107 including the transfer unit 14, the first and second temperature sensors 31 and 32 as the temperature sensor, the heating roller driving unit 28D, and the heater 28C of the heating roller 28B, and controls them.

The scan CPU 108 controls a CCD driving circuit 109 which drives a CCD 110. The image forming unit receives output of the CCD 110.

The drive controller 111 controls the recording medium transporting mechanism 19.

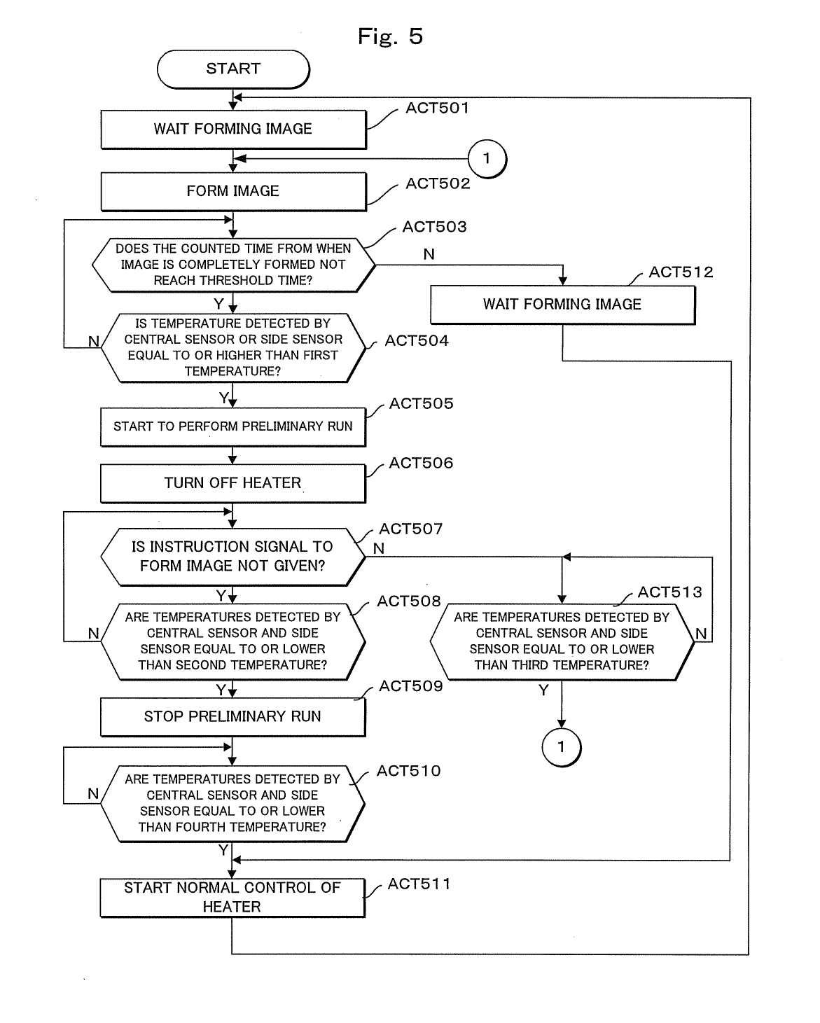

FIG. 5 is a flow chart illustrating action of the image forming apparatus 1. Overall action of the image forming apparatus 1 is as follows.

The image forming apparatus 1 cools down the heating roller 28B by performing the preliminary run and turning off the heater 28C at the same time when the temperature detected by the central sensor 31 or the side sensor 32 is equal to or higher than the first temperature.

Through this cooling down, the image forming apparatus 1 stops the preliminary run when the temperatures detected by the central sensor 31 and the side sensor 32 are equal to or lower than a second temperature, and starts normal control of the heater 28C when the temperatures are equal to or lower than a fourth temperature.

When the image forming apparatus 1 receives an instruction signal to form an image during cooling down, the image forming apparatus 1 continues cooling down until the heating roller 28B reaches a third temperature, which is the temperature for fixing, and then forms an image.

As illustrated in FIG. 5, in ACT 501, the image forming apparatus 1 waits until an instruction to form an image is given.

In ACT 502, the image forming apparatus 1 forms an image in accordance with the instruction to form the image.

In ACT 503, the image forming apparatus 1 counts time from when the image is completely formed and determines whether or not the counted time reaches a threshold time. When the image forming apparatus 1 determines that the counted time from when the image is completely formed does not reach the threshold time, the process proceeds to ACT 504. When it is determined that the counted time already reached the threshold time, the process proceeds to ACT 512.

In ACT 504, the image forming apparatus 1 determines whether or not the temperature detected by the central sensor 31 or the side sensor 32 is equal to or higher than the first temperature. When the image forming apparatus 1 determines that the temperature detected by the central sensor 31 or the side sensor 32 is equal to or higher than the first temperature, the process proceeds to ACT 505. When the image forming apparatus 1 determines that the temperature is lower than the first temperature, the process returns to ACT 503.

In ACT 505, the image forming apparatus 1 starts to perform the preliminary run.

Here, preliminary run means that the fixing device 28 is driven without transporting the recording medium and the heating roller 28B is rotated to lower the temperature of the heating roller 28B or to make the temperature uniform.

In ACT 506, the image forming apparatus 1 turns off the heater 28C.

In ACT 507, the image forming apparatus 1 determines whether or not the instruction signal to form an image is given. When the image forming apparatus 1 determines that the instruction signal is not given, the process proceeds to ACT 508. When the image forming apparatus 1 determines that the instruction signal is given, the process proceeds to ACT 513.

In ACT 508, the image forming apparatus 1 determines whether or not the temperatures detected by the central sensor 31 and the side sensor 32 are equal to or lower than the second temperature. When the image forming apparatus 1 determines that the temperatures detected by the central sensor 31 and the side sensor 32 are equal to or lower than the second temperature, the process proceeds to ACT 509. When the image forming apparatus 1 determines that the temperatures are higher than the second temperature, the process returns to ACT 507.

In ACT 509, the image forming apparatus 1 stops the preliminary run.

In ACT 510, the image forming apparatus 1 determines whether or not the temperatures detected by the central sensor 31 and the side sensor 32 are equal to or lower than a fourth temperature. When the image forming apparatus 1 determines that the temperatures detected by the central sensor 31 and the side sensor 32 are equal to or lower than the fourth temperature, the process proceeds to ACT 511. When the image forming apparatus 1 determines that the temperatures are higher than the fourth temperature, the process returns to ACT 510.

In ACT 511, the image forming apparatus 1 starts normal control of the heater 28C, and the process proceeds to ACT 501.

Here, the normal control for the heater 28C is the control to turn on or off the heater 28C such that the temperature of the heating roller 28B, more specifically, the temperatures detected by the central sensor 31 and the side sensor 32 are within a threshold temperature range.

In ACT 512, the image forming apparatus 1 waits until the instruction to form an image is given. The waiting state in this case is the normal standby state which is the same as the waiting state in ACT 501.

In ACT 513, the image forming apparatus 1 determines whether or not the temperatures detected by the central sensor 31 and the side sensor 32 are equal to or lower than the third temperature while maintaining the preliminary run. When the image forming apparatus 1 determines that the temperatures detected by the central sensor 31 and the side sensor 32 are equal to or lower than the third temperature, the process proceeds to ACT 502. When the image forming apparatus 1 determines that the temperatures are higher than the third temperature, the process returns to ACT 513.

Here, the relationship between the temperatures is as the following expression (1).

First Temperature>Second Temperature>Third Temperature>Fourth Temperature (1)

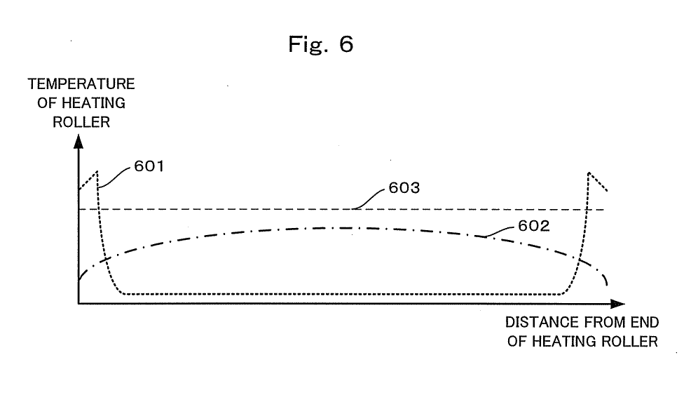

FIG. 6 is a diagram illustrating the temperature distribution in the longitudinal direction of the heating roller 28B. In FIG. 6, the vertical axis indicates the temperature of the heating roller 28B, and the horizontal axis indicates the distance from an end of the heating roller 28B. Graphs 601, 602, and 603 indicate the temperature distribution during feeding of a sheet, the temperature distribution after feeding the sheet, and a boundary temperature at which the overshoot phenomenon occurs, respectively.

As illustrated in FIG. 6, heat generated from both ends of the heating roller 28B after feeding the sheet is conducted toward the center of the heating roller 28B. However, even a portion having the highest temperature has a temperature equal to or lower than the boundary temperature at which the overshoot phenomenon occurs. Therefore, the overshoot phenomenon does not occur.

As described above, the image forming apparatus 1 according to the exemplar embodiment includes: an electrostatic latent image carrier that carries an electrostatic latent image; a developer supplying unit that supplies a developer to the electrostatic latent image and forms a developer image; a transfer roller 14C that transfers the developer image to a recording medium; a heating roller 28B with a heater 28C therein; a temperature sensor that detects the temperature of the heating roller 288; a heating roller driving mechanism 28D that drives the heating roller 288; and a controller 28E that cools down the heating roller 28B if the controller 28E determines that the temperature sensor detects a temperature equal to or higher than a first temperature within a threshold time after completion of image forming.

Therefore, it is possible to efficiently cool down the heating roller 28B after forming an image and to prevent the overshoot phenomenon, which is advantageous.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. A image forming apparatus comprising:
an electrostatic latent image carrier that carries an electrostatic latent image;
a developer supplying unit that supplies a developer to the electrostatic latent image and forms a developer image;
a transfer roller that transfers the developer image to a recording medium;
a heating roller with a heater therein;
a temperature sensor that detects a temperature of the heating roller;
a heating roller driving mechanism that drives the heating roller; and
a controller that cools down the heating roller if the controller determines that the temperature sensor detects a temperature equal to or higher than a first temperature within a threshold time after completion of image forming.

2. The apparatus according to claim 1,
wherein the cooling down includes turning off the heater and performing a preliminary run by driving the heating roller driving mechanism to rotate the heating roller.

3. The apparatus according to claim 2,
wherein the controller stops the preliminary run if the controller determines that the temperature sensor detects a temperature equal to or lower than a second temperature, which is lower than the first temperature, during cooling down.

4. The apparatus according to claim 3,
wherein, if the controller determines that there is a signal instructing to form an image is given during cooling down, the controller performs the cooling down until the temperature sensor detects a temperature equal to or lower than a third temperature, which is lower than the second temperature, and forms an image if the temperature sensor detects a temperature equal to or lower than the third temperature.

5. The apparatus according to claim 4,
wherein the third temperature is a temperature at which the heating roller performs fixing.

6. The apparatus according to claim 5,
wherein the controller drives the heater such that a temperature detected by the temperature sensor is within a threshold temperature range if the controller determines that the temperature sensor detects a temperature equal to or lower than a fourth temperature, which is lower than the third temperature, after the preliminary run is stopped.

7. An image forming method comprising:
forming an image;
counting time from if the image is completely formed; and
cooling down a heating roller if the controller determines that a temperature sensor detects a temperature equal to or higher than a first temperature within a threshold time after completion of image forming.

8. The method according to claim 7,
wherein the cooling down includes turning off a heater and performing a preliminary run by driving a heating roller driving mechanism to rotate the heating roller.

9. The method according to claim 8, further comprising:
stopping the preliminary run if the controller determines that the temperature sensor detects a temperature equal to or lower than a second temperature, which is lower than the first temperature, during the cooling down.

10. The method according to claim 9, if the controller determines that there is a signal instructing to form an image is given during the cooling down, further comprising:
performing the cooling down until the temperature sensor detects a temperature equal to or lower than a third temperature, which is lower than the second temperature; and
forming an image if the temperature sensor detects a temperature equal to or lower than the third temperature.

11. The method according to claim 10,
wherein the third temperature is a temperature at which the heating roller performs fixing.

12. The method according to claim 11, further comprising:
driving the heater such that a temperature detected by the temperature sensor is within a threshold temperature range if the controller determines that the temperature sensor detects a temperature equal to or lower than a fourth temperature, which is lower than the third temperature, after stopping the preliminary run.
